(19) United States
(12) Patent Application Publication
(10) Pub. No.: US 2011/0074651 A1
(43) Pub. Date: Mar. 31, 2011

(54) ASSEMBLY OF CLAMPING MECHANISM AND LNB AND DISH ANTENNA USING THE SAME

(75) Inventor: YA CHI LEE, HSINCHU (TW)

(73) Assignee: MICROELECTRONICS TECHNOLOGY INC., HSINCHU (TW)

(21) Appl. No.: 12/879,422

(22) Filed: Sep. 10, 2010

(30) Foreign Application Priority Data
Sep. 25, 2009 (TW) 098132414

(51) Int. Cl. H01Q 3/04

(52) U.S. Cl. 343/882

(57) ABSTRACT

An assembly comprises a clamping mechanism and an LNB (low noise block down converter). The clamping mechanism includes a first clamping part, a second clamping part, and a plurality of rectangular grooves. The LNB includes a shell, at least one flexible portion, and at least one rib portion. The first clamping part and the second clamping part clasp around the LNB, and are combined with each other by at least one fastening part. The at least one flexible portion is disposed on the shell of the LNB, and the rib portion is on the flexible portion. The plurality of rectangular grooves are closely arranged in parallel on the inner surface of the second clamping part, and the rib portion is contained in one of the rectangular grooves. By rotating the combination of the first clamping part and the second clamping part, the rib portion is forced to move between the rectangular grooves and then is positioned again. During the movement, the flexible portion is temporarily deformed.

### BACKGROUND OF THE INVENTION

(A) Field of the Invention

The present invention is related to an assembly of a clamping mechanism and an LNB and a dish antenna using the same, and more specifically, to a fastening apparatus for the tuning of the dish antenna angle.

(B) Description of Related Art

A satellite television system employs a dish antenna to collect satellite signals, and the signals are then reflected to low noise block down converters (LNB) positioned at the focus of the dish antenna for amplifying the signals and reducing their frequencies down to around 1 GHz, i.e., to an intermediate frequency. The adjusted signals are transmitted via a cable to an indoor television channel selector for selecting the signals of a desired channel, and the selected signals are then amplified, modulated and converted into video and audio signals for television viewing.

A dish antenna is a highly directional receiving device, which has to be precisely directed toward satellites in orbit at 36,000 kilometers altitude. For example, if a dish antenna with a 180 cm diameter shifts 2 cm horizontally, or 3 cm vertically, the signals will become weak or even disappear. In addition, if a dish antenna uses the Ka band, i.e., 26 to 40 GHz, an adjustment accuracy of 0.1 degrees is needed, and the tolerance has to be within 0.02 degrees for aiming at satellites precisely.

Normally, a dish antenna using the Ka band is adjusted by using a programmable logic controller (PLC) in control of servo motors; however, the high cost significantly limits its popularity.

FIG. 1 illustrates a known adjustable antenna apparatus 1 including a dish antenna 10, an LNB 11, a support rod 12, an adjustable dish bracket 13, a fixing arm 15, and an adjustable base member 14. When the adjustable antenna apparatus 1 is disposed in different manners by securing the adjustable base member 14 at different places such as a vertical wall surface or a horizontal or inclined roof, the adjustable dish bracket 13 is used for adjusting the orientation of the dish antenna 10 to obtain optimal signal-reception performance. When the fixing arm 15 is tightened to securely hold the LNB 11, however, the LNB 11 cannot be easily adjusted to an optimal receiving position by tuning its angle. If receiving signals are still weak after the fixing arm 15 is fastened, the fixing arm 15 needs to be loosened for releasing the LNB 11. The optimal receiving position is not easy to be properly set because of repeated assembly and disassembly, so the position adjustment is time-consuming.

### SUMMARY OF THE INVENTION

The present invention provides an assembly of a clamping mechanism and an LNB and a dish antenna using the same. After the clamping mechanism and the LNB are combined, the angle of the LNB can be fine-tuned relative to the clamping mechanism while the clamping mechanism still holds the LNB. The fine angle adjustment is conducted while the LNB is fastened, and the clamping mechanism does not need to be unfastened. Consequently, the optimal receiving position is easily located, and the position is not by a screwing or fastening movement.

In accordance with an embodiment of the present invention, an assembly of a clamping mechanism and an LNB comprises a clamping mechanism and an LNB (low noise block down converter). The clamping mechanism includes a first clamping part, a second clamping part, and a plurality of rectangular grooves. The LNB includes a shell, at least one flexible portion, and at least one rib portion. The first clamping part and the second clamping part clasp around the LNB, and are combined with each other by at least one fastening part. The at least one flexible portion is disposed on the shell of the LNB, and the rib portion is on the flexible portion. The plurality of rectangular grooves are closely arranged in parallel on the inner surface of the second clamping, and the rib portion is contained in one of the rectangular grooves. By rotating the combination of the first clamping part and the second clamping part, the rib portion is forced to move between the rectangular grooves and then is positioned again. During the movement, the flexible portion is temporarily deformed.

In accordance with an embodiment of the present invention, a dish antenna comprises a dish, an LNB, a clamping mechanism, an angle adjustment apparatus, and an adjustable stand. The dish is mounted on the angle adjustment apparatus, and the angle adjustment apparatus is connected to the adjustable stand. The clamping mechanism is fixed on the dish, and includes a first clamping part, a second clamping part, and a plurality of rectangular grooves. The LNB includes a shell, at least one flexible portion, and at least one rib portion. The first clamping part and the second clamping part clasp around the LNB, and are combined with each other by at least one fastening part. The at least one flexible portion is disposed on the shell of the LNB, and the rib portion is on the flexible portion. The plurality of rectangular grooves are closely arranged in parallel on the inner surface of the second clamping part, and the rib portion is contained in one of the rectangular grooves. By rotating the combination of the first clamping part and the second clamping part, the rib portion is forced to move between the rectangular grooves and then is positioned again. During the movement, the flexible portion is temporarily deformed.

### BRIEF DESCRIPTION OF THE DRAWINGS

FIG. 1 is a perspective diagram showing a conventional adjustable antenna apparatus;

FIG. 2 is a perspective diagram showing an assembly of a clamping mechanism and an LNB in accordance with an embodiment of the present invention;

FIG. 3A is an exploded diagram showing an assembly of a clamping mechanism and an LNB in accordance with an embodiment of the present invention;

FIG. 3B is a partially magnified diagram of portion A in FIG. 3A;

FIG. 3C is a partially magnified diagram of portion B in FIG. 3B;

FIG. 4A is a schematic diagram of a flexible portion in accordance with an embodiment of the present invention; and

FIG. 4B is a schematic diagram of ratchets in accordance with an embodiment of the present invention.

### DETAILED DESCRIPTION OF THE INVENTION

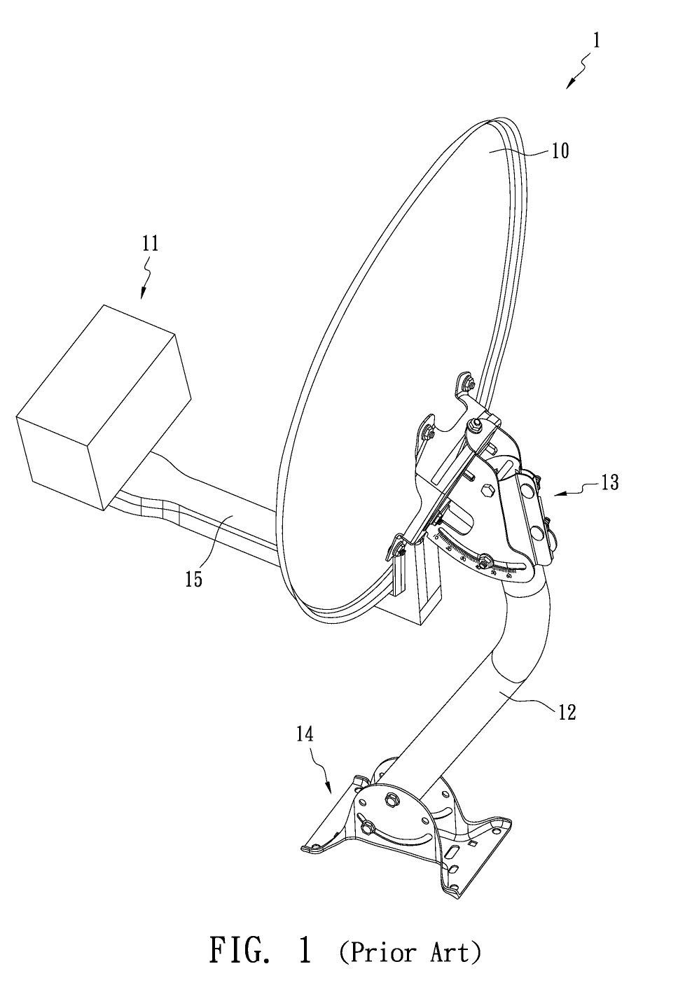

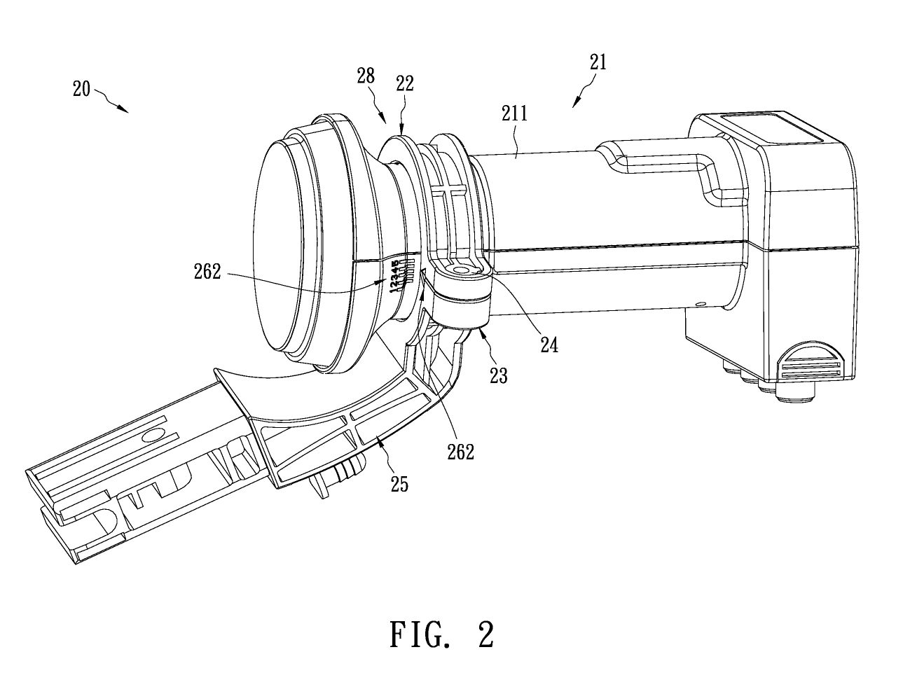

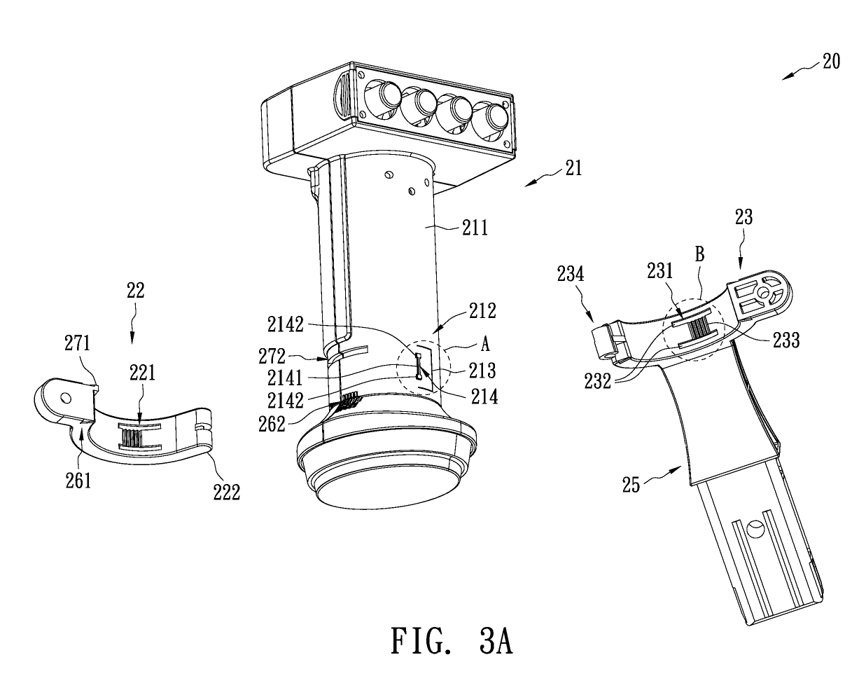

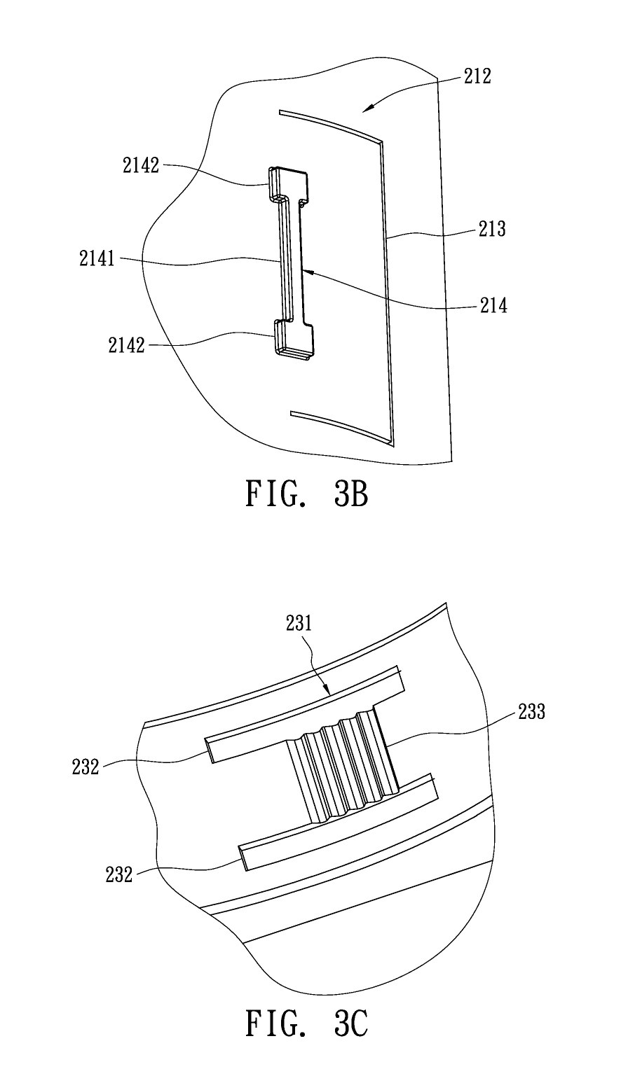

FIG. 2 is a perspective diagram showing an assembly of a clamping mechanism and an LNB in accordance with an embodiment of the present invention. FIG. 3A is an exploded diagram showing an assembly of a clamping mechanism and an LNB in accordance with an embodiment of the present invention. The assembly 20 comprises a clamping mechanism 28 and an LNB 21. The clamping mechanism 28 includes a first clamping part 22, a second clamping part 23, and at least one ratchet 221. The LNB 21 includes a shell 211, at least one flexible portion 212 (referring to FIG. 3), and at least one rib portion 214 (referring to FIG. 3). The first clamping part 22 and the second clamping part 23 clasp around the LNB 21, and are combined with each other by at least one fastening part 24. The first clamping part 22 and the second clamping part 23 are able to pivot relative to each other through a first pivoting portion 222 and a second pivoting portion 234. The second clamping part 23 is connected to a connection arm 25. The connection arm 25 is connected to a fixing arm (referring to reference numeral 15 in FIG. 1) so as to be fixed to a dish (referring to reference numeral 10 in FIG. 1).

As shown in FIG. 3B, the at least one flexible portion 212 is disposed on the shell 211 of the LNB 21, and the rib portion 214 is on the flexible portion 212. The rib portion 214 comprises a detent part 2141 and two guiding parts 2142 disposed on two ends of the detent part 2141. The rib portion 214 is not limited by the present embodiment, and has various changes its configuration. The two guiding parts 2142 make the rib portion 214 easy to move. In fact, the detent part 2141 by itself is enough for the embodiment and can function without the guiding parts 2142. As shown in FIG. 3C, the plurality of rectangular grooves 233 are closely arranged in parallel on the inner surface of the second clamping part 23, and the rib portion 214 is contained in one of the rectangular grooves 233. Each of the lateral guiding grooves 232 is on one side of the rectangular grooves 233 so the guiding parts 2142 on the two ends of the rib portion 214 can slide in the lateral guiding grooves 232. The plurality of the rectangular grooves 233 and the lateral guiding grooves 232 are named as a ratchet 231. As to the present embodiment, another ratchet 221 is disposed on the second clamping part 23. Another rib portion (not shown) engaged in the ratchet 221 is opposite the rib portion 214 with a relative angle of 180° so the rotation motion for the position adjustment is more stable and the clamping force is also increased. The number of pairs of the rib portion and the ratchet is not limited by the present embodiment, and can be one or more. The rib portions and the ratchets can be disposed on the parting lines, but the rib portions and the ratchets of the present embodiment are not disposed on the parting lines.

By rotating the combination of the first clamping part 22 and the second clamping part 23, the rib portion 2141 is forced to move between the rectangular grooves 233 and then is positioned again. During the movement, the flexible portion 212 is temporarily deformed. The flexible portion 212 is a cantilever defined by a C-shaped slit 213 on the shell 211. When the combination of the first clamping part 22 and the second clamping part 23 is rotated, the rib portion 214 staying in one of the rectangular grooves 233 will mount a high partition between the rectangular grooves 233, and then will fall into the next one of the rectangular grooves 233. Accordingly, the flexible portion 212 can absorb force applied to the rib portion 214 by the second clamping part 23. Because the shell 221 is partially pushed down, the rib portion 214 on it can successfully pass through the high partition between two rectangular grooves 233.

When the combination of the first clamping part 22 and the second clamping part 23 is rotated, the finger 261 on the first clamping 22 or the second clamping 23 can be aligned with one of the angle indexes 262 on the shell 211 so the angle adjustment is easy and definite. To further stabilize and limit the rotation movement, an external guiding groove 272 is provided on the shell 211. An external guiding rail 271 disposed on the first clamping part 22 can engage with the external guiding groove 272 so the external guiding rail 271 slides in the external guiding groove 272 and is constrained by the inner walls of the external guiding groove 272.

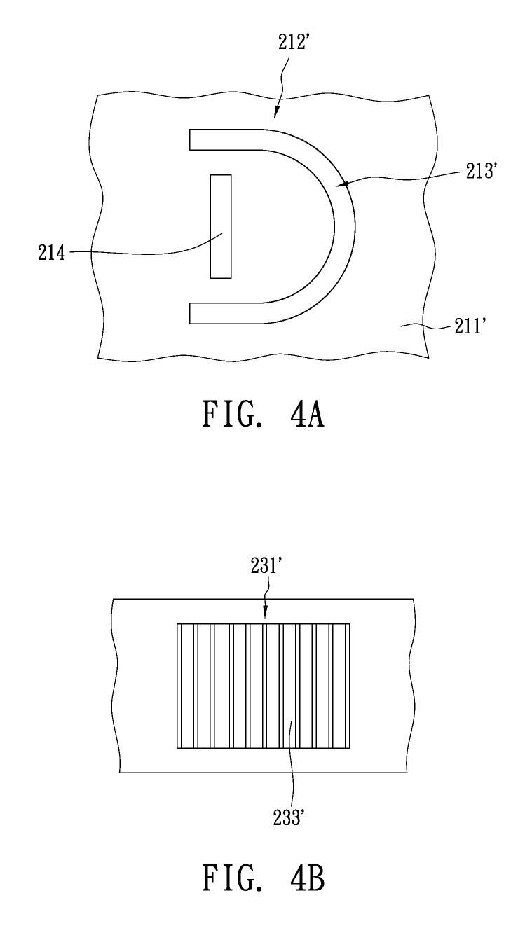

FIG. 4A shows a flexible portion 212′ in accordance with another embodiment of the present invention. The flexible portion 212′ is a cantilever defined by a semicircular-shaped slit 213′ on the shell 211′. The rib portion 214′ is provided on the surface of the flexible portion 212′. Compared with FIG. 3, there are no guiding parts on two ends of the rib portion 214′.

FIG. 4B shows a ratchet in accordance with another embodiment of the present invention. To match the design of the rib portion 214′, the ratchet 231′ only comprises a plurality of adjacent grooves 233′.

The above-described embodiments of the present invention are intended to be illustrative only. Numerous alternative embodiments may be devised by those skilled in the art without departing from the scope of the following claims.

What is claimed is:

1. An assembly of a clamping mechanism and an LNB (low noise block down converter), comprising:
an LNB, including:
a shell;
at least one flexible portion disposed on the shell; and
at least one rib portion disposed on the flexible portion; and
a clamping mechanism, including:
a first clamping part;
a second clamping part clasping around the LNB with the first clamping part; and
a plurality of rectangular grooves closely arranged in parallel on an inner surface of the second clamping part;
whereby the rib portion is contained in one of the rectangular grooves.

2. The assembly of a clamping mechanism and LNB of claim 1, wherein the shell of the LNB further includes a slit around the flexible portion so as to make the flexible portion act as a cantilever.

3. The assembly of a clamping mechanism and LNB of claim 1, further comprising at least one fastening part combining the first clamping part and the second clamping part.

4. The assembly of a clamping mechanism and LNB of claim 1, wherein the first clamping part and the second clamping part are able to pivot relative to each other.

5. The assembly of a clamping mechanism and LNB of claim 1, wherein the rib portion includes a detent part and two guiding parts disposed on two ends of the detent part, and the width of the two guiding parts is larger than the width of the detent part.

6. The assembly of a clamping mechanism and LNB of claim 5, further comprising two lateral guiding grooves on one side of the rectangular grooves so that the guiding parts on the two ends of the rib portion can slide in the lateral guiding grooves.

7. The assembly of a clamping mechanism and LNB of claim 1, further comprising an external guiding groove disposed on the shell and an external guiding rail disposed on the first clamping part engaging with the external guiding groove so that the external guiding rail slides in the external guiding groove and is constrained by the inner walls of the external guiding groove.

8. The assembly of a clamping mechanism and LNB of claim 1, wherein the rib portion staying in one of the rectangular grooves will mount a high partition between the rectangular grooves when the combination of the first clamping part and the second clamping part is rotated, and then the rib portion will fall into the next one of the rectangular grooves.

9. The assembly of a clamping mechanism and LNB of claim 1, further comprising a connection arm connected to the second clamping part, wherein the connection arm is connected to a fixing arm so as to be fixed to a dish.

10. The assembly of a clamping mechanism and LNB of claim 1, wherein the number of rib portions is plural, the rib portions are respectively disposed at equiangular locations of the shell, and the rectangular grooves corresponding to the rib portions are provided on inner surfaces of the first clamping part and the second clamping part.

11. A dish antenna, comprising:
a dish;
an angle adjustment apparatus fixing the dish;
an adjustable stand fixing the angle adjustment apparatus;
an LNB, including:
a shell;
at least one flexible portion disposed on the shell; and
at least one rib portion disposed on the flexible portion; and
a clamping mechanism, including:
a first clamping part;
a second clamping part clasping around the LNB with the first clamping part; and
a plurality of rectangular grooves closely arranged in parallel on an inner surface of the second clamping part;
whereby the rib portion is contained in one of the rectangular grooves.

12. The dish antenna of claim 11, wherein the shell of the LNB further includes a slit around the flexible portion so as to make the flexible portion act as a cantilever.

13. The dish antenna of claim 11, further comprising at least one fastening part combining the first clamping part and the second clamping part.

14. The dish antenna of claim 11, wherein the first clamping part and the second clamping part are able to pivot relative to each other.

15. The dish antenna of claim 11, wherein the rib portion includes a detent part and two guiding parts disposed on two ends of the detent part, and the width of the two guiding parts is larger than the width of the detent part.

16. The dish antenna of claim 15, further comprising two lateral guiding grooves on one side of the rectangular grooves so that the guiding parts on the two ends of the rib portion can slide in the lateral guiding grooves.

17. The dish antenna of claim 11, further comprising an external guiding groove disposed on the shell and an external guiding rail disposed on the first clamping part engaging with the external guiding groove so that the external guiding rail slides in the external guiding groove and is constrained by inner walls of the external guiding groove.

18. The dish antenna of claim 11, wherein the rib portion staying in one of the rectangular grooves will mount a high partition between the rectangular grooves when the combination of the first clamping part and the second clamping part is rotated, and then the rib portion will fall into the next one of the rectangular grooves.

19. The dish antenna of claim 11, further comprising a connection arm connected to the second clamping part, wherein the connection arm is connected to a fixing arm so as to be fixed to a dish.

20. The dish antenna of claim 11, wherein the number of rib portion is plural, the rib portions are respectively disposed at equiangular locations of the shell, and the rectangular grooves corresponding to the rib portions are provided on inner surfaces of the first clamping part and the second clamping part.
